(19) United States
(12) Patent Application Publication
(10) Pub. No.: US 2025/0027344 A1
(43) Pub. Date: Jan. 23, 2025

(54) INTERLOCKING MECHANISM FOR A CABINET

(71) Applicants: ACT Engineering Sdn. Bhd., Batu Pahat (MY); Nexus Berxatu Sdn. Bhd., Muar (MY)

(72) Inventor: Yan Hua Lee, Muar (MY)

(73) Assignees: ACT Engineering Sdn. Bhd., Batu Pahat (MY); Nexus Berxatu Sdn. Bhd., Muar (MY)

(21) Appl. No.: 18/767,364

(22) Filed: Jul. 9, 2024

(30) Foreign Application Priority Data
Jul. 17, 2023 (MY) PI2023004276
May 24, 2024 (MY) PI2024003027

(51) Int. Cl. E05B 65/463

(52) U.S. Cl. CPC E05B 65/463

(57) ABSTRACT

A cabinet including a plurality of drawers and an interlocking mechanism that includes a locking bar having a spaced protrusions, and rotatable blocks having a first portion pivotably connected to an inner side wall of the cabinet, a second portion engagable by the sliding mechanism of a respective drawer, and a third portion that is engagable with one of the protrusions, wherein when one of the drawers is moving towards the open position, the sliding mechanism of that drawer engages the second portion of the corresponding rotatable block to cause the third portion of the corresponding rotatable block to engage with the respective protrusions and to move the locking bar to a locked position, the remaining protrusions of the locking bar are also moved to a position that intercept a rotation pathway of the remaining rotatable blocks such that the sliding mechanisms of the remaining drawers are prevented from movement.

### CROSS-REFERENCE TO RELATED APPLICATION

The instant application claims priority to Malaysia Patent Application Serial No. PI2023004276 filed Jul. 17, 2023 and Malaysia Patent Application Serial No. PI2024003027 filed May 24, 2024, the entire specifications of both of which are expressly incorporated herein by reference.

### FIELD OF THE INVENTION

The invention relates to a cabinet. More particularly, the invention relates to a cabinet with improved interlocking mechanism.

### BACKGROUND OF THE INVENTION

A cabinet with drawers is commonly used in places such as households and workplaces to store articles in an organized manner. Conventionally, the drawers of the cabinet can be freely opened and closed in a selective manner. However, such cabinet may be one of the household or workplace hazards, whereby multiple opened drawers at a time may result in toppling of the cabinet due to change in centre of gravity. Furthermore, the multiple opened drawers may be exploited by mischievous children in the form of stepping stones to reach a greater height. Consequently, such hazards may cause physical injury to nearby occupants or damage to assets.

Over the years, safety locking mechanism has been incorporated into a cabinet with drawers to minimize risk of the aforementioned accidents. For instance, China Patent No. CN106837009A discloses a multi-drawer locking device for a cabinet with multi-layer drawers. The multi-drawer locking device generally comprises a guide groove, a first slider, a plurality of second slider, and a wedge-shaped block disposed at front end of an inner rail of each drawer. Each of the second slider comprises a limiting block and a roller. When one of the drawer is opened by pulling outwards, the roller corresponding to the opened drawer moves along the wedge-shaped block and the inner rail of the drawer, which drives the second sliders of the remaining drawers above the opened drawer to move upwardly. Consequently, the position of the limiting blocks of the remaining drawers above the opened drawer blocks the wedge-shaped blocks of the remaining drawers from outward movement, thereby preventing the remaining drawers above the opened drawer from being pulled outwardly. On the other hand, the movement of the second sliders of the remaining drawers below the opened drawer is blocked by the limiting block and the inner rail of the drawer, thereby preventing the remaining drawers below the opened drawers from being pulled outwardly.

However, surface degradation may occur on the second sliders and the guide groove, thereby causing the second sliders of the remaining drawers to be stuck within the guide groove when the opened drawer is closed. Consequently, this prevents the remaining drawers above the previously opened drawer to be opened, where the limiting blocks are partially or fully blocking the inner rails.

Accordingly, it would be desirable to provide a cabinet that overcomes the abovementioned problem. This invention provides a solution to the problem.

### SUMMARY OF THE INVENTION

One objective of the invention is to provide a cabinet that prevents more than one drawer to be opened at a time. Particularly, the cabinet comprises an interlocking mechanism that allows only one drawer to be opened while locking the remaining drawer.

In a first aspect of the invention, there is provided a cabinet comprising a plurality of drawers, each coupled with a sliding mechanism for the respective drawer to be slid between a closed position and an open position; and an interlocking mechanism which is triggered, by the movement of one of the drawers, to switch between a locked configuration where one of the drawers is in the open position while the remaining drawers are locked in the closed position and an unlocked configuration where any one of the drawers can be moved from the closed position to the open position, wherein the interlocking mechanism comprises a locking bar slidably disposed on an inner side wall of the cabinet, having a plurality of spaced protrusions distributed along a length of the locking bar, wherein the locking bar is movable between a locked position and an unlocked position, a plurality of rotatable blocks, each block having a first portion pivotably connected to the inner side wall of the cabinet, a second portion engageable by the sliding mechanism of a respective drawer, and a third portion that is engageable with one of the protrusions, wherein when one of the drawers is moving towards the open position, the sliding mechanism of that particular drawer engages the second portion of the corresponding rotatable block to cause the third portion of the corresponding rotatable block to engage with the respective protrusions and to move the locking bar to the locked position, the remaining protrusions of the locking bar are also moved to a position that intercept a rotation pathway of the remaining rotatable blocks such that the sliding mechanisms of the remaining drawers are prevented from movement.

Preferably, the sliding mechanism is a roller slide.

Preferably, the rotatable block is a T-shaped block.

Preferably, the rotatable block comprises a through hole for receiving a fastening means.

Preferably, the rotatable block comprises a chamfer for facilitating the movement of the drawer.

Preferably, the rotatable block comprises a receiving portion for receiving a supporting means such that the rotatable block is held at an outward position.

Preferably, the cabinet further comprises a guiding means for guiding movement of the locking bar.

Preferably, the cabinet further comprises a limiting member for securing the movement of the locking bar within the guiding means.

Preferably, the cabinet can be a multi-column cabinet having a first column storage space and a second column storage space separated by an intermediate panel, at least two of the locking bars are respectively disposed on one side of the intermediate panel, wherein the locking bars may be linked to move in a synchronized manner between the locked position and the unlocked position.

Preferably, the intermediate panel may include a slot through which a linkage can move along a length of the slot and pass through the slot to connect the locking bars on the respective sides of the intermediate panel.

Preferably, the cabinet may further comprise a second interlocking mechanism for securing all the drawers in their closed position when the cabinet is tilted.

Preferably, the second interlocking mechanism may comprise a further protrusion on the locking bar and a further rotatable block pivotably connected to the inner side wall in such a way that it rotates in relative to the cabinet, while the cabinet is tilted, to a position that engages the further protrusion, thereby preventing the locking bar, the rotatable blocks, and the drawers from any movement.

Preferably, the rotatable blocks can be engaged by further attachment members of the drawers instead of their respective sliding mechanism.

Preferably, the rotatable blocks can be connected to a movable bar that is slidable on the inner side wall between an operational position where the sliding mechanisms of the drawers are engagable with their respective rotatable blocks and a non-operational position where the sliding mechanisms are not engagable with their respective rotatable blocks.

Preferably, the cabinet may further comprise an anti-tipping mechanism that simultaneously prevents the cabinet from toppling over and disables functions of the interlocking mechanism.

Preferably, the anti-tipping mechanism can be slidably attached to the cabinet in such a way that it can move between a first position where the functions of the anti-tipping mechanism are disabled and a second position where the functions of the anti-tipping mechanism are activated.

Preferably, the anti-tipping mechanism may comprise a base extended out from the cabinet to increase a footprint of the cabinet, and an attachment portion that facilitates attachment of the anti-tipping mechanism to the cabinet and suspends the movable bar in the non-operational position.

Preferably, the attachment portion may further suspend the locking bar in a position where the protrusions on the locking bar does not obstruct the sliding path way of the sliding mechanisms of the drawers.

Preferably, the attachment portion may include at least one groove, at least one fastening member attached to the cabinet and being slidable along the grooves, and a tapered surface for guiding the movable bar and/or the locking bar to the suspended position.

Preferably, the anti-tipping mechanism may comprise an elongate body having a first end for suspending the movable bar in the non-operational position and a second end extended out from the cabinet for mounting to a wall structure.

Preferably, the cabinet may further comprise a bar holder for suspending the movable bar and/or the locking bar in such a way that the functions of the interlocking mechanism are disabled.

In a second aspect of the invention, there is provided a multi-column cabinet comprises a first column storage space and a second column storage space separated by an intermediate panel, whereby each column storage space comprises a plurality of drawers, each coupled with a sliding mechanism for the respective drawer to be slid between a closed position and an open position; and an interlocking mechanism which is triggered, by the movement of one of the drawers, to switch between a locked configuration where one of the drawers is in the open position while the remaining drawers are locked in the closed position and an unlocked configuration where any one of the drawers can be moved from the closed position to the open position, wherein the interlocking mechanism comprises a locking bar slidably disposed on each side of the intermediate panel, having a plurality of spaced protrusions distributed along a length of the locking bar, wherein the locking bars on both sides of the intermediate panel are linked to move in a synchronized manner between a locked position and an unlocked position, and a plurality of rotatable blocks, each block having a first portion pivotably connected to the intermediate panel, a second portion engagable by an attachment member of a respective drawer, and a third portion that is engagable with one of the protrusions of the locking bars; wherein when one of the drawers is moving towards the open position, the attachment member of that particular drawer engages the second portion of the corresponding rotatable block to cause the third portion of the corresponding rotatable block to engage with the respective protrusions and to move the locking bars to the locked position, the remaining protrusions of the locking bars are also moved to a position that intercept a rotation pathway of the remaining rotatable blocks such that the remaining drawers are prevented from movement.

Preferably, the sliding mechanism can be a roller slide.

Preferably, the attachment member can be a part of the sliding mechanism.

Preferably, the rotatable block can be a T-shaped block.

Preferably, the rotatable block may comprise a through hole for receiving a fastening means.

Preferably, the rotatable block may comprise a chamfer for facilitating the movement of the drawer.

Preferably, the rotatable block may comprise a receiving portion for receiving a supporting means such that the rotatable block is held at an outward position.

Preferably, the cabinet may further comprise a guiding means for guiding movement of the locking bar.

Preferably, the cabinet may further comprise a limiting member for securing the movement of the locking bar within the guiding means.

Preferably, the intermediate panel may include a slot through which a linkage can pass through the slot to connect the locking bars on the respective sides of the intermediate panel and move along a length of the slot to allow the linked locking bars to move between the locked position and the unlocked position in the synchronized manner.

Preferably, the cabinet may further comprise a second interlocking mechanism for securing all the drawers in their closed position when the cabinet is tilted.

Preferably, the second interlocking mechanism may comprise a further protrusion on the locking bar and a further rotatable block pivotably connected to the intermediate panel in such a way that it rotates in relative to the cabinet, while the cabinet is tilted, to a position that engages the further protrusion, thereby preventing the locking bar, the rotatable blocks, and the drawers from any movement.

Preferably, the rotatable blocks can be connected to a movable bar that is slidable on the intermediate panel between an operational position where the attachment members of the drawers are engagable with their respective rotatable blocks and a non-operational position where the attachment members are not engagable with their respective rotatable blocks.

Preferably, the cabinet may further comprise an anti-tipping mechanism that simultaneously prevents the cabinet from toppling over and disables functions of the interlocking mechanism.

Preferably, the anti-tipping mechanism can be slidably attached to the cabinet in such a way that it can move between a first position where the functions of the anti-tipping mechanism are disabled and a second position where the anti-tipping mechanism is in operation.

Preferably, the anti-tipping mechanism may comprise a base extended out from the cabinet to increase a footprint of the cabinet, and an attachment portion that facilitates attachment of the anti-tipping mechanism to the cabinet and suspends the movable bar in the non-operational position.

Preferably, the attachment portion may further suspend the locking bar in a position where the protrusions on the locking bar does not obstruct the sliding path way of the attachment member of the drawers.

Preferably, the attachment portion may include at least one groove, at least one fastening member attached to the cabinet and being slidable along the grooves, and a tapered surface for guiding the movable bar and/or the locking bar to the suspended position.

Preferably, the anti-tipping mechanism may comprise an elongate body having a first end for suspending the movable bar in the non-operational position and a second end extended out from the cabinet for mounting to a wall structure.

Preferably, the cabinet may further comprise a bar holder for suspending the movable bar and/or the locking bar in such a way that the functions of the interlocking mechanism are disabled.

In a third aspect of the invention, there is provided a cabinet comprises a plurality of drawers, each coupled with a sliding mechanism for the respective drawer to be slid between a closed position and an open position; and a second interlocking mechanism for securing all the drawers in their closed position when the cabinet is tilted.

Preferably, the cabinet may further comprise an interlocking mechanism which is triggered, by the movement of one of the drawers, to switch between a locked configuration where one of the drawers is in the open position while the remaining drawers are locked in the closed position and an unlocked configuration where any one of the drawers can be moved from the closed position to the open position. The interlocking mechanism may comprise a locking bar slidably disposed on an inner side wall of the cabinet, having a plurality of spaced protrusions distributed along a length of the locking bar, wherein the locking bar is movable between a locked position and an unlocked position, a plurality of rotatable blocks, each block having a first portion pivotably connected to the inner side wall of the cabinet, a second portion engage able by the sliding mechanism of a respective drawer, and a third portion that is engagable with one of the protrusions, wherein when one of the drawers is moving towards the open position, the sliding mechanism of that particular drawer engages the second portion of the corresponding rotatable block to cause the third portion of the corresponding rotatable block to engage with the respective protrusions and to move the locking bar to the locked position, the remaining protrusions of the locking bar are also moved to a position that intercept a rotation pathway of the remaining rotatable blocks such that the sliding mechanisms of the remaining drawers are prevented from movement.

Preferably, the second interlocking mechanism may comprise a further protrusion on the locking bar and a further rotatable block pivotably connected to the intermediate panel in such a way that it rotates in relative to the cabinet, while the cabinet is tilted, to a position that engages the further protrusion, thereby preventing the locking bar, the rotatable blocks, and the drawers from any movement.

In a fourth aspect of the invention, there is provided a cabinet comprises a plurality of drawers, each coupled with a sliding mechanism for the respective drawer to be slid between a closed position and an open position; an interlocking mechanism which is triggered, by the movement of one of the drawers, to switch between a locked configuration where one of the drawers is in the open position while the remaining drawers are locked in the closed position and an unlocked configuration where any one of the drawers can be moved from the closed position to the open position; and an anti-tipping mechanism that simultaneously prevents the cabinet from toppling over and disables functions of the interlocking mechanism.

Preferably, the interlocking mechanism may comprise a locking bar slidably disposed on an inner side wall of the cabinet, having a plurality of spaced protrusions distributed along a length of the locking bar, wherein the locking bar is movable between a locked position and an unlocked position, a plurality of rotatable blocks, each block having a first portion pivotably connected to the inner side wall of the cabinet, a second portion engagable by the sliding mechanism of a respective drawer, and a third portion that is engagable with one of the protrusions, wherein when one of the drawers is moving towards the open position, the sliding mechanism of that particular drawer engages the second portion of the corresponding rotatable block to cause the third portion of the corresponding rotatable block to engage with the respective protrusions and to move the locking bar to the locked position, the remaining protrusions of the locking bar are also moved to a position that intercept a rotation pathway of the remaining rotatable blocks such that the sliding mechanisms of the remaining drawers are prevented from movement.

Preferably, the rotatable blocks can be connected to a movable bar that is slidable on the intermediate panel between an operational position where the attachment members of the drawers are engagable with their respective rotatable blocks and a non-operational position where the attachment members are not engagable with their respective rotatable blocks.

Preferably, the anti-tipping mechanism can be slidably attached to the cabinet in such a way that it can move between a first position where the functions of the anti-tipping mechanism are disabled and a second position where the anti-tipping mechanism is in operation.

Preferably, the anti-tipping mechanism may comprise a base extended out from the cabinet to increase a footprint of the cabinet, and an attachment portion that facilitates attachment of the anti-tipping mechanism to the cabinet and suspends the movable bar in the non-operational position.

Preferably, the attachment portion may further suspend the locking bar in a position where the protrusions on the locking bar does not obstruct the sliding path way of the attachment member of the drawers.

Preferably, the attachment portion may include at least one groove, at least one fastening member attached to the cabinet and being slidable along the grooves, and a tapered surface for guiding the movable bar and/or the locking bar to the suspended position.

Preferably, the anti-tipping mechanism may comprise an elongate body having a first end for suspending the movable bar in the non-operational position and a second end extended out from the cabinet for mounting to a wall structure.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic diagram illustrating a cabinet when all drawers are in a closed position.

FIG. 2 is a schematic diagram illustrating an interlocking mechanism of the cabinet when all the drawers are in the closed position.

FIG. 3 is a schematic diagram illustrating an enlarged view of the interlocking mechanism of the cabinet taken from Section A in FIG. 2.

FIG. 4 is a schematic diagram illustrating the cabinet when one of the drawers is moving towards an open position.

FIG. 5 is a schematic diagram illustrating the interlocking mechanism of the cabinet when one of the drawers is moving towards the open position.

FIG. 6 is a schematic diagram illustrating an enlarged view of the interlocking mechanism of the cabinet taken from Section B in FIG. 5.

FIG. 7 is a schematic diagram illustrating an enlarged view of the interlocking mechanism of the cabinet taken from Section C in FIG. 5.

FIG. 8 is a schematic diagram illustrating the cabinet when the drawers is in the open position.

FIG. 9 is a schematic diagram illustrating the interlocking mechanism of the cabinet when the drawer is in the open position.

FIG. 10 is a schematic diagram illustrating an enlarged view of the interlocking mechanism of the cabinet taken from Section D in FIG. 9.

FIG. 11 is a schematic diagram illustrating an enlarged view of the interlocking mechanism of the cabinet taken from Sections E in FIG. 9.

FIG. 12 is a schematic diagram illustrating a front view of a locking bar.

FIG. 13 is a schematic diagram illustrating a side view of the locking bar.

FIG. 14 is a schematic diagram illustrating an isometric view of a rotatable block.

FIG. 15 is a schematic diagram illustrating a side view of the rotatable block.

FIG. 16 is a schematic diagram illustrating insertion of the drawer into the cabinet.

FIG. 17 is a schematic diagram illustrating an enlarged view of the interlocking mechanism of the cabinet taken from Sections F in FIG. 16.

FIG. 18 is a schematic diagram illustrating an isometric view of a fastening means.

FIG. 19 is a schematic diagram illustrating an isometric view of a limiting member.

FIG. 20 is a schematic diagram illustrating a multi-column cabinet.

FIG. 21 is a schematic diagram illustrating an isometric view of an intermediate panel of the multi-column cabinet.

FIG. 22 is a schematic diagram illustrating a side view of the intermediate panel.

FIG. 23 is a schematic diagram illustrating the multi-column cabinet when one of the drawers is in the closed position.

FIG. 24 is a schematic diagram illustrating the multi-column cabinet when one of the drawers is moved to the open position.

FIG. 25 is a schematic diagram illustrating a second interlocking mechanism coupled to the interlocking mechanism.

FIG. 26 is a schematic diagram illustrating the second interlocking mechanism in operation when the cabinet is tilted.

FIG. 27 is a schematic diagram illustrating the second interlocking mechanism coupled to another type of interlocking mechanism.

FIG. 28 is a schematic diagram illustrating an isometric view of a drawer coupled with a further attachment member.

FIG. 29 is a schematic diagram illustrating a position of the respective further attachment members when the drawers are in the closed position.

FIG. 30 is a schematic diagram illustrating the position of the respective further attachment members when one of the drawers is moved to the open position.

FIG. 31 is a schematic diagram illustrating a first embodiment of an anti-tipping mechanism.

FIG. 32 is a schematic diagram illustrating the anti-tipping mechanism in operation.

FIG. 33 is a schematic diagram illustrating the interlocking mechanism being disabled by the anti-tipping mechanism.

FIG. 34 is a schematic diagram illustrating the other type of interlocking mechanism being disabled by the anti-tipping mechanism.

FIG. 35 is a schematic diagram illustrating a second embodiment of the anti-tipping mechanism.

FIG. 36 is a schematic diagram illustrating the anti-tipping mechanism in operation.

FIG. 37 is a schematic diagram illustrating the interlocking mechanism being disabled by the anti-tipping mechanism.

FIG. 38 is a schematic diagram illustrating an enlarged view of the anti-tipping mechanism.

FIG. 39 is a schematic diagram illustrating the other type of interlocking mechanism being disabled by the anti-tipping mechanism.

FIG. 40 is a schematic diagram illustrating a third embodiment of the anti-tipping mechanism.

FIG. 41 is a schematic diagram illustrating the anti-tipping mechanism in operation.

FIG. 42 is a schematic diagram illustrating the interlocking mechanism being disabled by the anti-tipping mechanism.

FIG. 43 is a schematic diagram illustrating the other type of interlocking mechanism being disabled by the anti-tipping mechanism.

FIG. 44 is a schematic diagram illustrating a bar holder attached to a first position within the cabinet.

FIG. 45 is a schematic diagram illustrating an isometric view of the bar holder.

FIG. 46 is a schematic diagram illustrating the bar holder attached to a second position within the cabinet.

FIG. 47 is a schematic diagram illustrating the interlocking mechanism being disabled by the anti-tipping mechanism.

FIG. 48 is a schematic diagram illustrating the other type of interlocking mechanism being disabled by the bar holder.

### DETAILED DESCRIPTION OF THE INVENTION

The invention will now be described in greater detail, by way of example, with reference to the drawings.

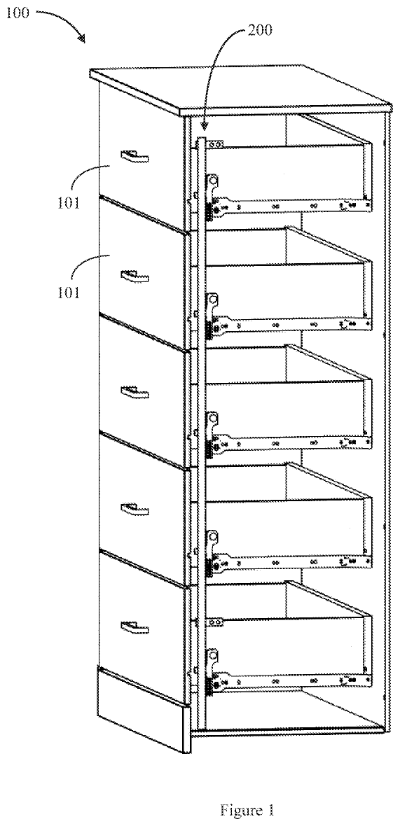

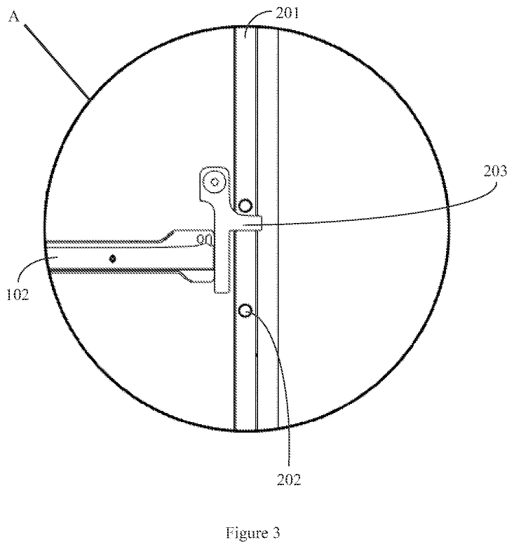

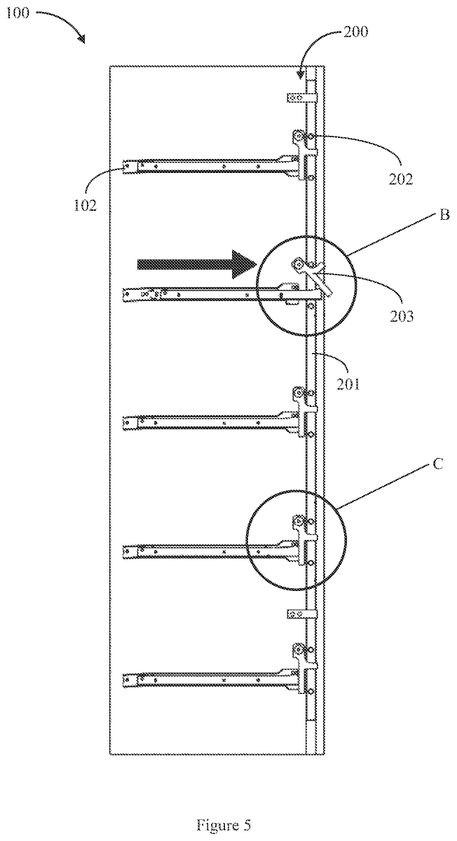

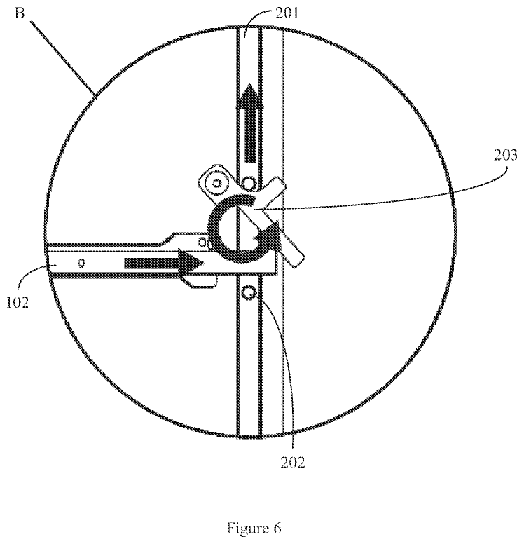

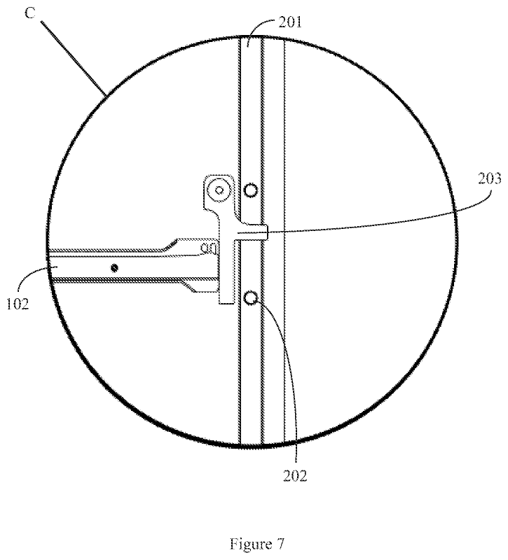

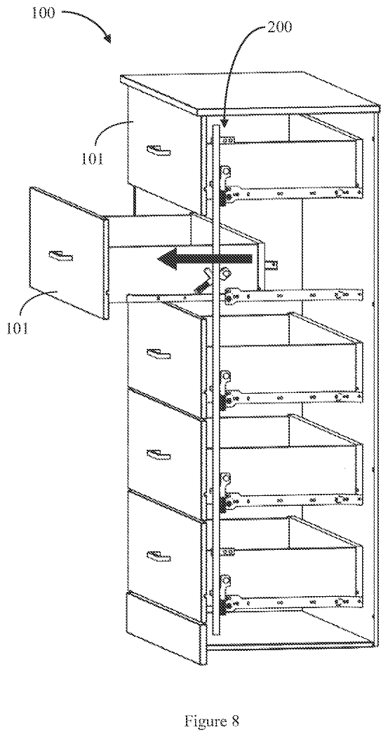

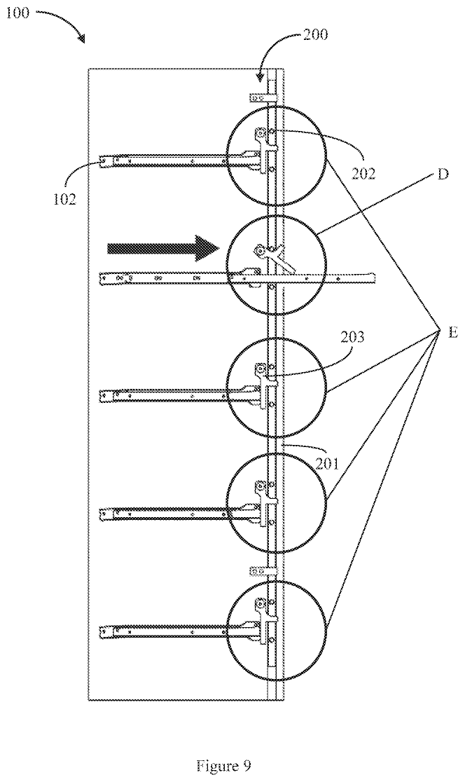

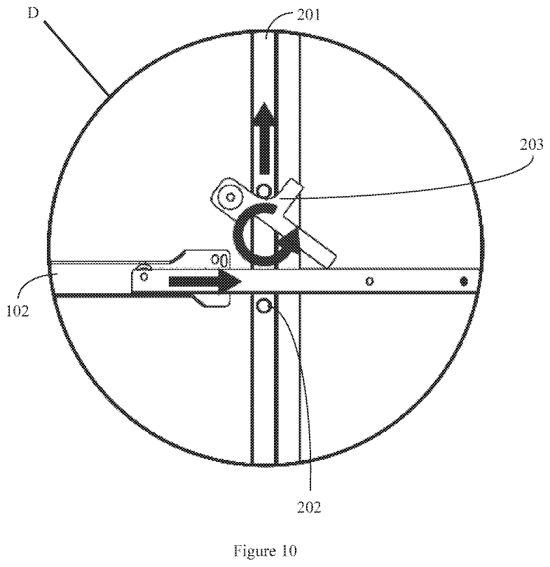

FIGS. 1-11 illustrate schematic diagrams of a preferred embodiment of a cabinet (100). In the preferred embodiment of the invention, the cabinet (100) generally comprises a plurality of drawers (101) and an interlocking mechanism (200). Preferably, the drawers (101) are vertically arranged next to each other within the main body of the cabinet (100). It should be noted that the number of drawers (101) may vary depending on the type of cabinet (100).

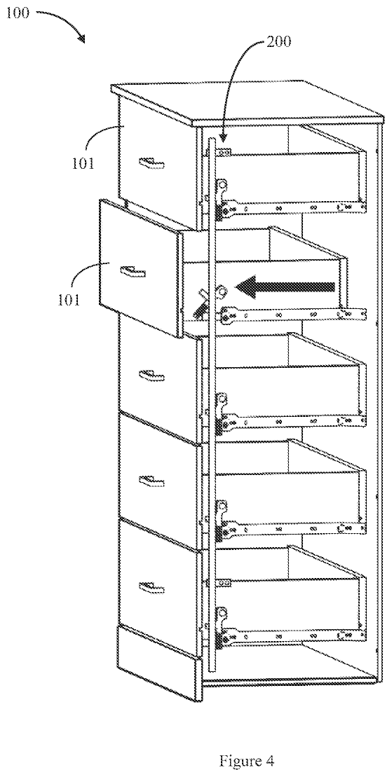

Each of the drawers (101) is coupled with a sliding mechanism (102) such that the drawers (101) are slidable between a closed position where the drawer (101) is inaccessible and an open position where the drawer (101) is accessible for depositing and/or withdrawing an article. FIGS. 1-3 illustrate the schematic diagrams of the cabinet (100) where the drawers (101) are in the closed position, whereas FIGS. 8-11 illustrate the schematic diagrams (101) of the cabinet (100) where one of the drawers (101) are in the open position. Additionally, FIGS. 4-7 illustrate the schematic diagram of the cabinet (100) where one of the drawers (101) is moving towards the open position. Preferably, the sliding mechanism (102) is a roller slide disposed on an outer side wall of each of the drawers (101).

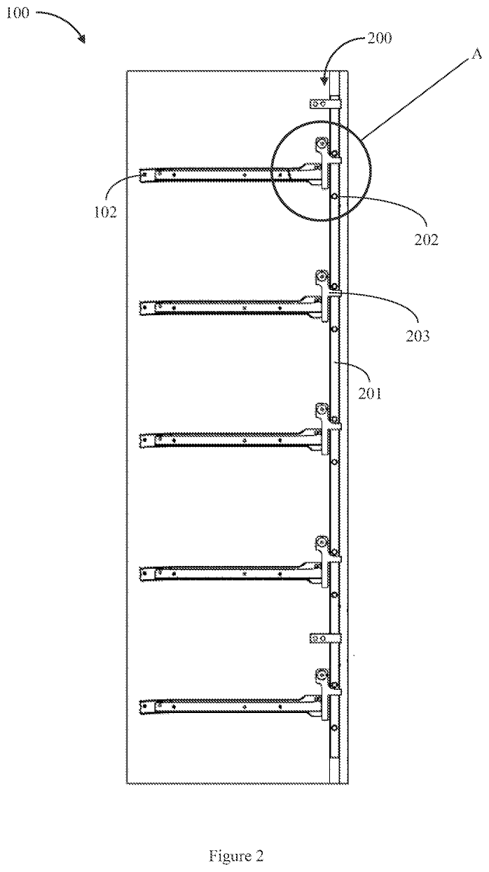

In the preferred embodiment of the invention, the interlocking mechanism (200) is configured to allow only one drawer (101) to be opened at a time. The interlocking mechanism (200) is triggered by the movement of one of the drawers (101) to switch between a locked configuration where one of the drawers (101) is in the open position while the remaining drawers (101) are locked in the closed position and an unlocked configuration where any one of the drawers (101) can be moved from the closed position to the open position, as illustrated in FIGS. 2, 5, and 9 progressively. Preferably, the interlocking mechanism (200) generally comprises a locking bar (201) and a plurality of rotatable blocks (203).

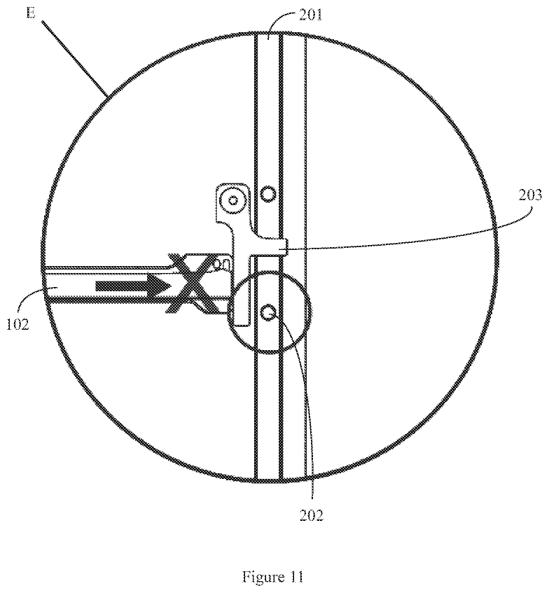

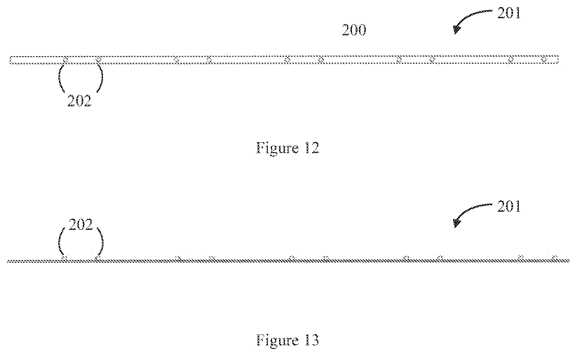

The locking bar (201) is preferably slidably disposed on an inner side wall of the cabinet (100). Referring to FIGS. 12 and 13, the locking bar (201) comprises a plurality of spaced protrusion (202) distributed along a length of the locking bar (201), wherein the locking bar (201) is movable between a locked position and an unlocked position. The distribution of the protrusions (202) on the locking bar (201) corresponds to position of the drawers (101) in the cabinet (100). Preferably, each of the drawers (101) corresponds to a pair of the protrusions (202), resulting in a total number of protrusions (202) that is equivalent to number of drawers (101) in the cabinet (100) multiply by 2. Based on the abovementioned distribution, each of the drawers (101) corresponds to an upper protrusion (202) and a lower protrusion (202).

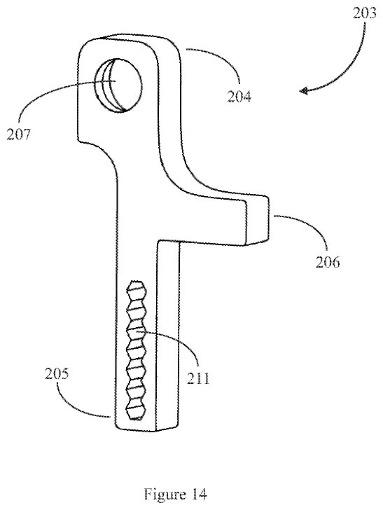

Referring to FIG. 14, each of the rotatable blocks (203) has a first portion (204) that is pivotably connected to the inner side wall of the cabinet (100), a second portion (205) that is engagable by the sliding mechanism (102) of a respective drawer (101), and a third portion (206) that is engagable with one of the protrusions (202). Preferably, the rotatable blocks (203) are pivoted along a length of the inner side wall and the cabinet (100), as illustrated in FIGS. 1, 4, and 8.

Each of the rotatable blocks (203) is preferably positioned between the locking bar (201) and its respective sliding mechanism (102). In addition, each of the rotatable blocks (203) are preferably in an orientation where the third portion (206) is positioned between the upper protrusion (202) and the lower protrusion (202), and engagable with the upper protrusion (202). In such orientation, each of the upper protrusions (202) functions as assistance for the movement of the locking bar (201). On the other hand, each of the lower protrusions (202) functions as an obstacle for intercepting rotation of the rotatable blocks (203) when one of the drawers (101) is moving towards the open position. Preferably, the rotatable block (203) is a T-shaped block which comprises a main body having the first portion (204) and the second portion (205) that are opposing to one another, and a branched body having the third portion (206) as illustrated in FIG. 14. The main body and the branched body are preferably perpendicular to one another.

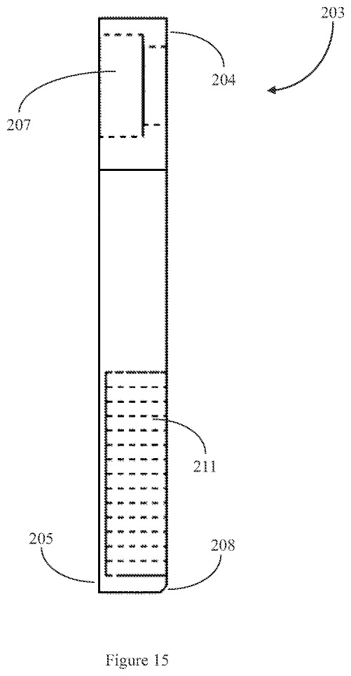

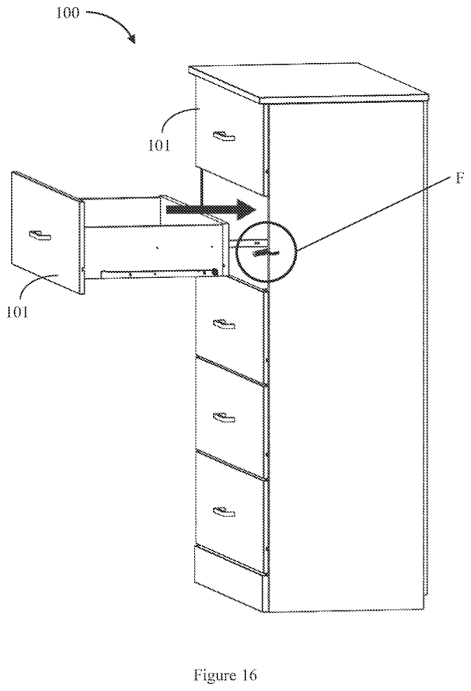

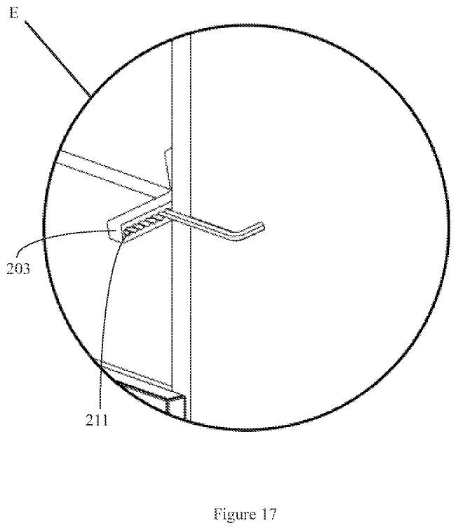

Referring back to FIG. 15, each of the rotatable blocks (203) preferably comprises a chamfer (208) for facilitating movement of the drawers (101). Preferably, the chamfer (208) is located at the third portion (206) of the rotatable block (203) that is in contact with the sliding mechanism (102) during movement of the drawer (101) between the closed position and the open position. Flat and smooth surface of the chamfer (208) allows the third portion (206) of the rotatable block (203) to slide along the sliding mechanism (102) more smoothly as compared to a sharp vertex. Preferably, the chamfer (208) has an angle ranges between 20° and 60°. More preferably, the chamfer (208) has an angle of 45°. Advantageously, this facilitates movement of the drawers (101) between the closed position and the open position, as well as insertion and removal of the drawers (101). Additionally, the rotatable block (203) comprises a receiving portion (211) for receiving a supporting means. Preferably, the receiving portion (211) is located at the second portion (205) of the rotatable block (203). Referring to FIGS. 16 and 17, the receiving portion (211) and the supporting means allow the rotatable block (203) to be held at an outward position to facilitate insertion of the drawers (101). Preferably, the supporting means can be but not limited to an Allen key.

Additionally, the rotatable block (203) preferably comprises a through hole (207) at the first portion (204) for receiving a fastening means (209). The through holes (207) and the fastening means (209) secure the positions of the rotatable blocks (203) and allow rotation of the rotatable blocks (203) when in use. By way of example, the fastening means (209) can be but not limited to a screw, nut and bolt, a rivet, or a nylon washer. Preferably, the fastening means (209) is a nylon washer as illustrated in FIG. 18. Advantageously, the improved wear-and-tear resistance and reduced friction of the nylon washer facilitates the rotation of the rotatable block (203) when the drawer (101) moves between the open position and the closed position.

When one of the drawers (101) is moving towards the open position, the sliding mechanism (102) of that particular drawer (101) engages the second portion (205) of the corresponding rotatable block (203). The engagement between the sliding mechanism (102) and the second portion (205) of the corresponding rotatable block (203) causes the corresponding rotatable block (203) to rotate about the fastening means (209) at the first portion (204). Such rotation causes the third portion (206) of the corresponding rotatable block (203) to engage with the respective protrusions (202), and subsequently moves the locking bar (201) to the locked position. The movement of the locking bar (201) to the locked position results in movements of the remaining protrusions (202) to a position that intercept rotation pathways of the remaining rotatable block (203) such that the sliding mechanisms (102) of the remaining drawers (101) are prevented from movement. The rotatable blocks (203) act as a centralized moving part for the locking mechanism (200) of the cabinet (100). Particularly, the first (204), second (205), and third portions (206) of the rotatable block (203) each engages with different parts of the cabinet (100) to move the locking bar (201) between the locked position and the unlocked position. Advantageously, this eases inspection and maintenance of the locking mechanism (200).

During the rotation of the rotatable block (203) corresponding to the moving drawer (101), the third portion (206) preferably engages with the respective upper protrusion (202), thereby lifting the locking bar (201) to the locked position. When the locking bar (201) is lifted to the locked position, the remaining protrusions (202) are also lifted where the positions of lower protrusions (202) intercept the rotation pathways of the remaining rotatable block (203). When attempting to move a second drawer (101) to the open position, the corresponding sliding mechanism (102) engages with the second portion (205) of the rotatable block (203) of the second drawer (101). However, the respective lower protrusion (202) intercepts the rotation pathway of the rotatable block (203) due to the locked position of the locking bar (201), thereby preventing the second drawer (101) to be opened.

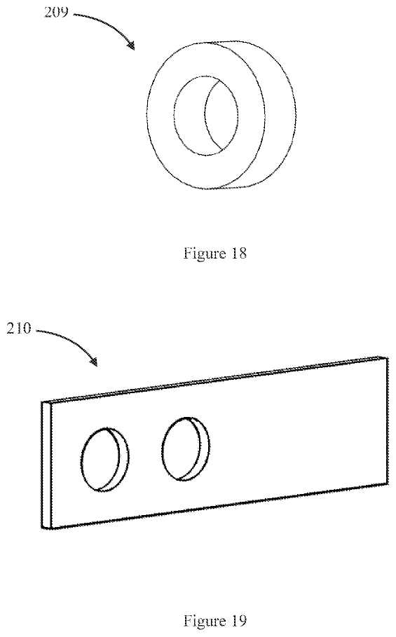

In the preferred embodiment of the present invention, the cabinet (100) further comprises a guiding means for guiding the movement of the locking bar (201). Preferably, the guiding means is in the form of a groove that houses the locking bar (201) therewithin. The groove preferably extends vertically along the inner side wall of the cabinet (100). Alternatively, the guiding means can be a guide rail that is removably attached on the inner side wall of the cabinet (100). Preferably, the locking bar (201) is housed within the guiding means in which a side surface having the protrusions (202) faces outwardly towards a side wall of the drawers (101). Additionally, the cabinet (100) further comprises a limiting member (210) for securing the movement of the locking bar (201) within the guiding means. Preferably, the limiting member (210) can be a metallic piece as illustrated in FIG. 19. The limiting member partially seals the guiding means such that the locking bar (201) does not derail from the guiding means. Alternatively, the limiting member (210) can be a bracket that partially encloses the locking bar (201) within the guiding means to prevent derailment of the locking bar (201).

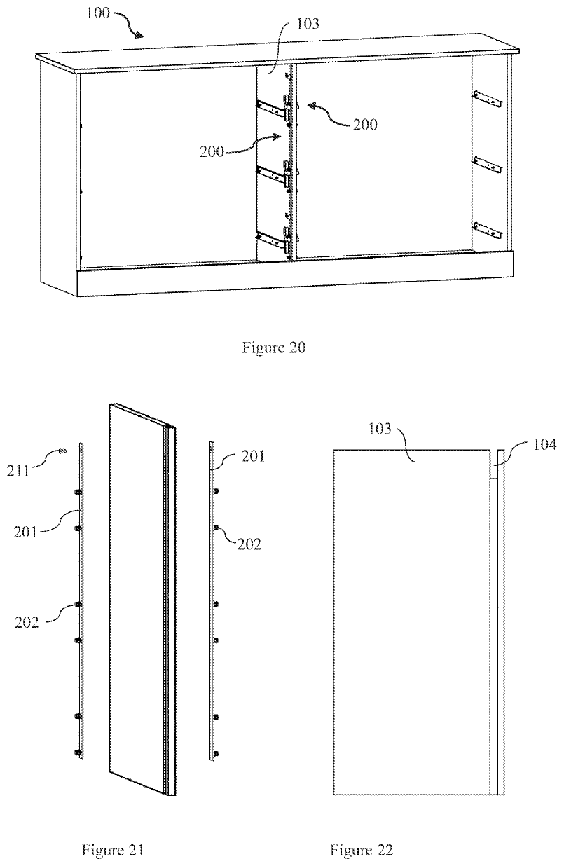

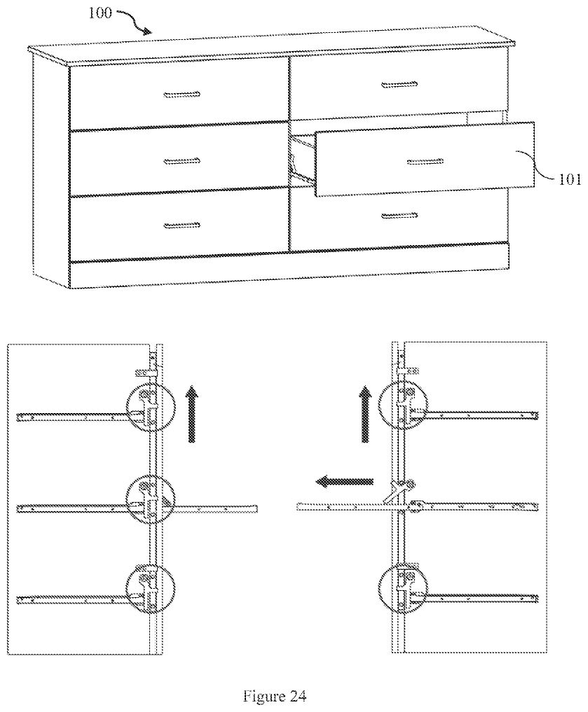

FIGS. 20-24 illustrates a further embodiment of the cabinet (100). In this embodiment, the cabinet (100) is a multi-column cabinet that has a first column storage space and a second column storage space. The first and second column storage spaces are separated by an intermediate panel (103). Such intermediate panel (103) can be considered as an inner side wall of each independent column storage space. The first column storage space and the second column storage space respectively comprises a plurality of drawers (101), each coupled with the sliding mechanism (102) for the respective drawer to be slid between the closed position and the open position. The multi-column cabinet also comprises the interlocking mechanism (200) that operates between the locked configuration and the unlocked configuration. In this embodiment, the interlocking mechanism (200), instead of having one locking bar (201) as described in the previous embodiment shown in FIGS. 1-11, has a pair of the locking bars (201) respectively disposed on each side of the intermediate panel (103). The locking bars (201) on both sides of the intermediate panel (103) are linked to have a synchronized movement such that when a drawer (101) from one of the column is moved to the open position, the remaining drawers (101) in both the columns are then secured in their closed position.

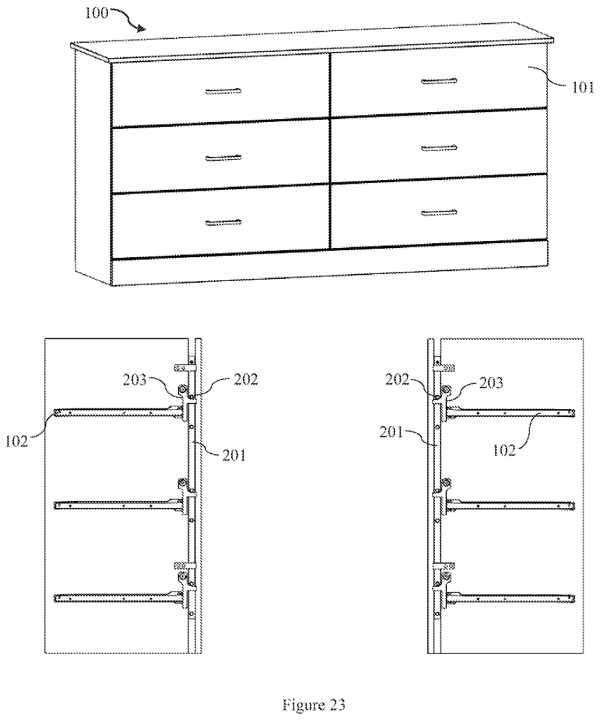

As shown in FIGS. 21 and 22, the intermediate panel (103) may include a slot through which a linkage (211) can pass through the slot (104) to connect the locking bars (201) on either side of the intermediate panel (103). The linkage (211) can be a rivet pin that joins the top ends of the pair of locking bars (103). Additionally, the linkage (211) can move along a length of the slot (104), allowing the connected locking bars (201) to move between the locked position and the unlocked position in the synchronized manner.

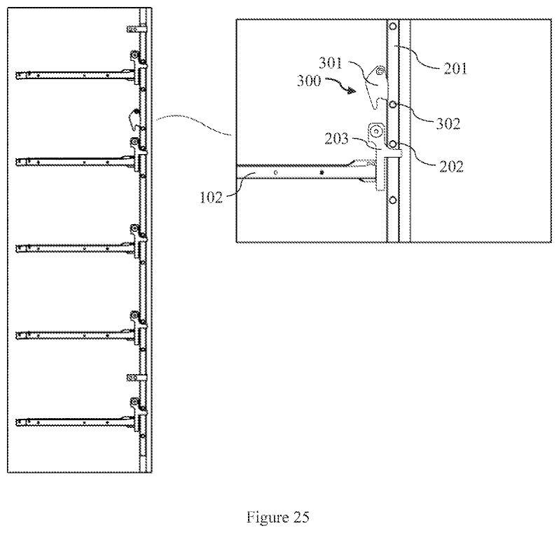

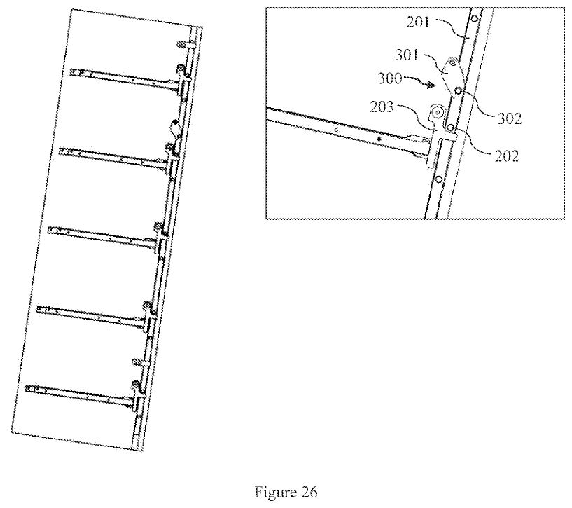

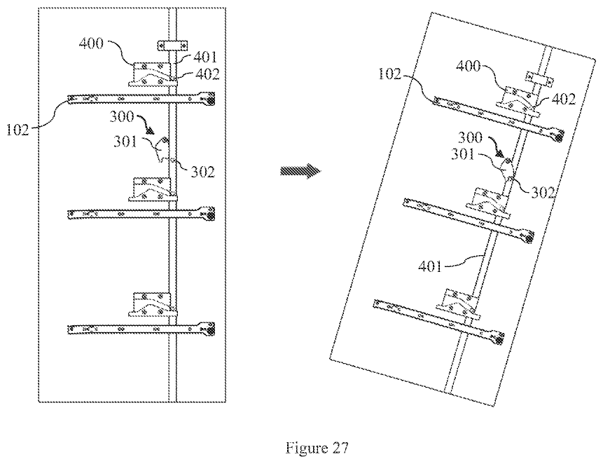

Referring to FIGS. 25 and 26, a second interlocking mechanism (300) can be provided for securing all the drawers (101) in their closed position when the cabinet (100) is tilted due to external forces such as an earthquake. The second interlocking mechanism (300) comprises a further protrusion (302) on the locking bar (201) and a further rotatable block (301) pivotably connected to the inner side wall or the intermediate panel (103). When the cabinet (100) tilts, the sliding mechanisms (102) of the drawers (101) will engage with their respective rotatable blocks (203) to lift the locking bar (201). However, the further rotatable block (301) simultaneously rotates relative to the cabinet (100), under the influence of gravitational force, moving to a position where at least a part of the further rotatable block (301) engages the further protrusion (302). This engagement obstructs the lifting movement of the locking bar (201), preventing any movement of the rotatable blocks (203) and the sliding mechanism (102) of each drawer (101).

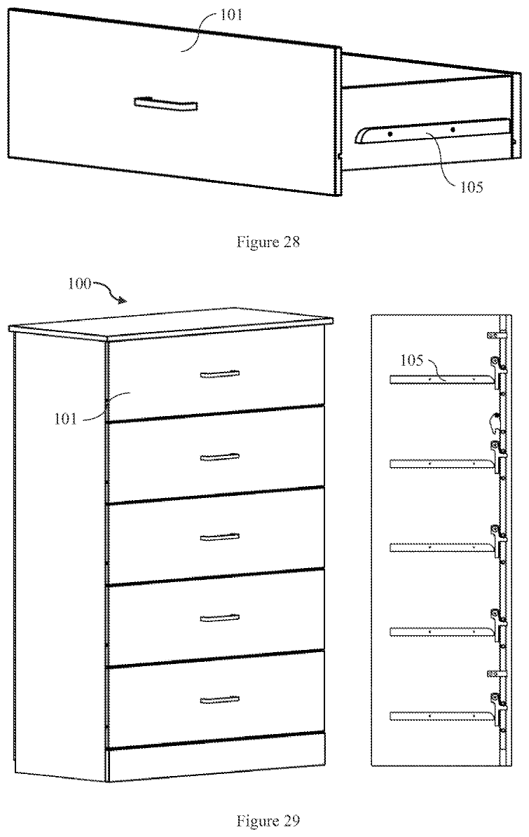

It should be noted that the second interlocking mechanism (300) can be coupled with alternative embodiments of the interlocking mechanism to achieve the same function. In general, as long as these alternative embodiments include a locking bar (401) with protrusions (402) and means (400) for lifting the locking bar (401) when one or more of the drawers (101) are moving towards their open position, the second interlocking mechanism (300) can obstruct the lifting movement of the locking bar (401) and thereby securing the drawers (101) in their closed position. FIG. 27 illustrates an example of an alternative embodiment of the interlocking mechanism with which the second interlocking mechanism (300) is coupled. In this example, the interlocking mechanism includes a slanted channel (400), a locking bar (401) and protrusions (402) on the locking bar (401). When a drawer (101) moves towards the open position, a corresponding protrusion (402) is guided by the channel (400) to lift or lower the locking bar (401). As shown in FIG. 27, the further rotatable block (301) of the second interlocking mechanism (300) is rotated to the position that obstructs the lifting movement of the locking bar (401), preventing any movement of the sliding mechanisms (102) of the drawers (101).

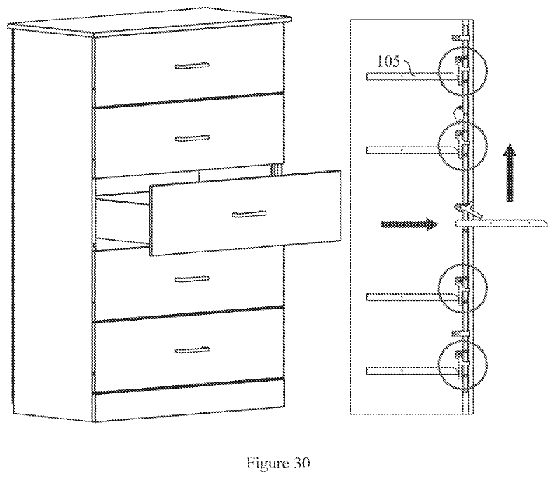

FIGS. 28-30 illustrates an example of each drawer (101) attached with a further attachment member (105). In this example, the rotatable blocks (203) are engaged by the further attachments (105) of the drawers (101), instead of their respective sliding mechanism (102), to operate the interlocking mechanism (200). In one embodiment, the further attachment member (105) can be a component of the sliding mechanism (102).

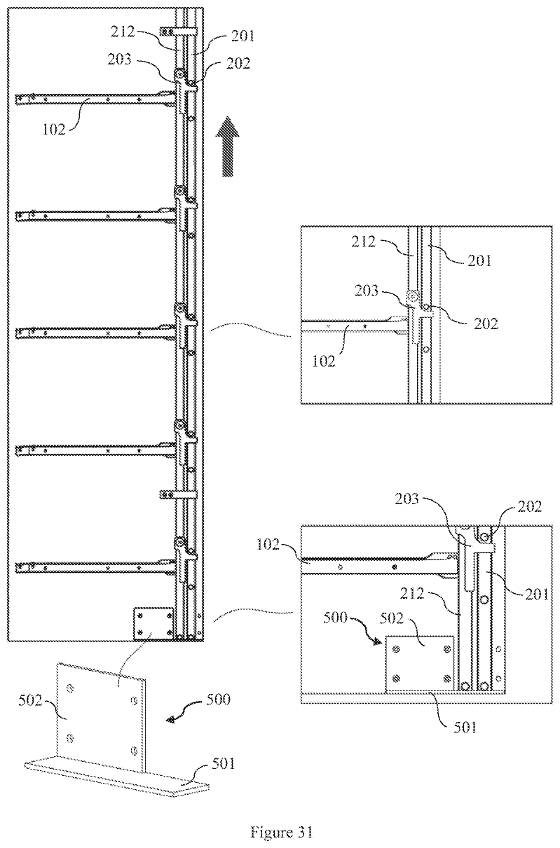

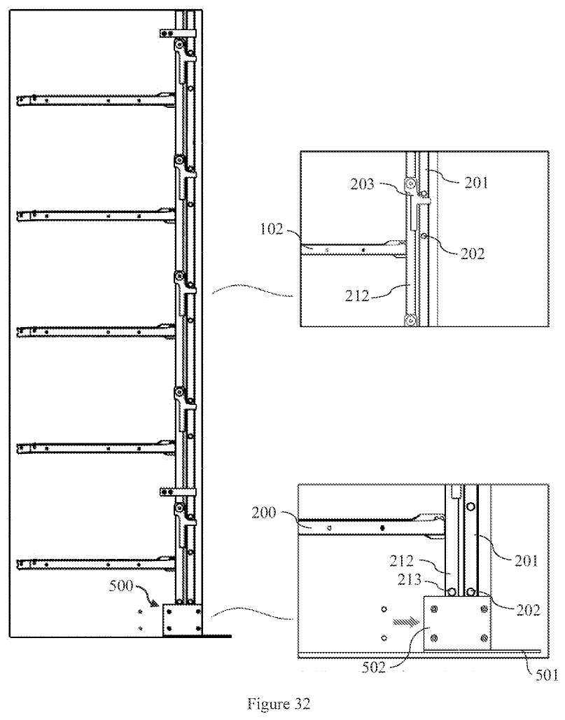

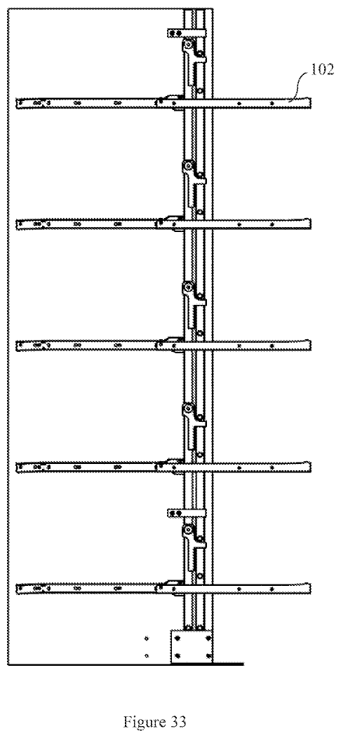

Referring to FIGS. 31-33, a first embodiment of an anti-tipping mechanism (500) can be provided to simultaneously perform a first function that prevents the cabinet (100) from toppling over and a second function that disables the functions of the interlocking mechanism (200). To enable the anti-tipping mechanism (500), the rotatable blocks (203) are required to be movable in a manner similar to the locking bar (201). This can be achieved by connecting the rotatable blocks (203) to a movable bar (212) that slides along the inner side wall or intermediate panel (103). The movable bar (212) can move between an operational position, where the sliding mechanisms (102) of the drawers (101) are engagable with their respective rotatable blocks (203), and a non-operational position, where the rotatable blocks (203) are positioned in such a way that the sliding mechanisms (102) no longer can interact with the rotatable blocks (203).

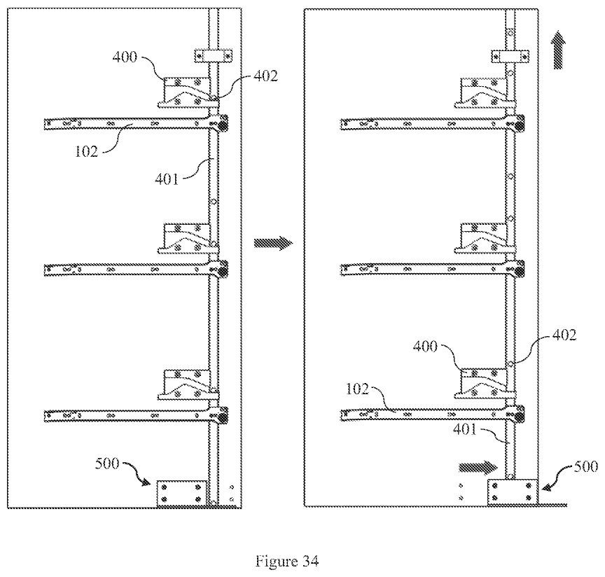

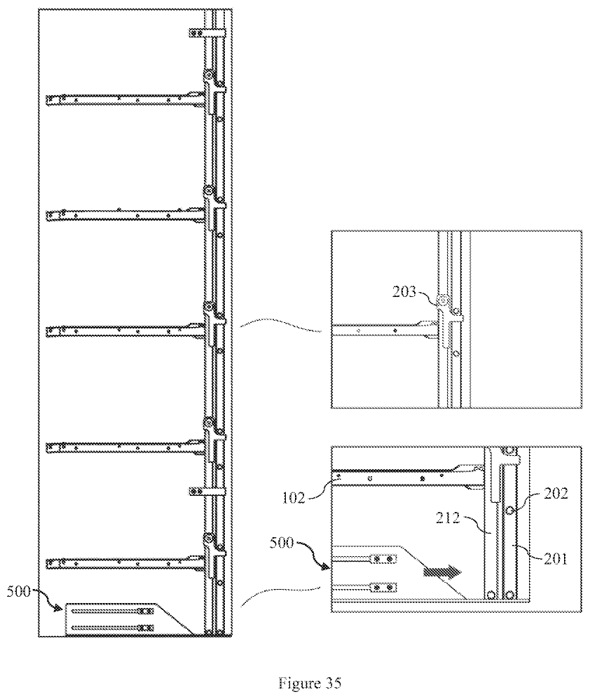

The anti-tipping mechanism (500) can be attached to the cabinet (100) in either a first position or in a second position. In the first position, the anti-tipping mechanism (500) can be non-operational or perform only one function. For example, the anti-tipping mechanism (500) may solely perform the first function, solely perform the second function, or be in a non-operational state. In the second position, the anti-tipping mechanism (500) can simultaneously perform both first and second functions. Preferably, the first embodiment of the anti-tipping mechanism (500) comprises a base (501) and an attachment portion (502). The first function is performed when the base (501) is attached to the cabinet (100) via the attachment portion (502) in such a way that it extends out from the cabinet (100) to increase a footprint of the cabinet (100). The second function is performed when the movable bar (212) is suspended in the non-operational position by the attachment portion (502). Preferably, the movable bar (212) is suspended on the attachment portion (502) via a bottommost protrusion (213) of the movable bar (212). Alternatively, if the protrusions (202) of the locking bar (201) are obstructing the pathway of the sliding mechanisms (102) of the drawers (101), the attachment portion (502) may further suspend the locking bar (201) in a position where the protrusions (202) do not obstruct the pathway of these sliding mechanisms (102). Similarly, the anti-tipping mechanism (500) can be used to disable the alternative embodiment of the interlocking mechanism as shown in FIG. 34.

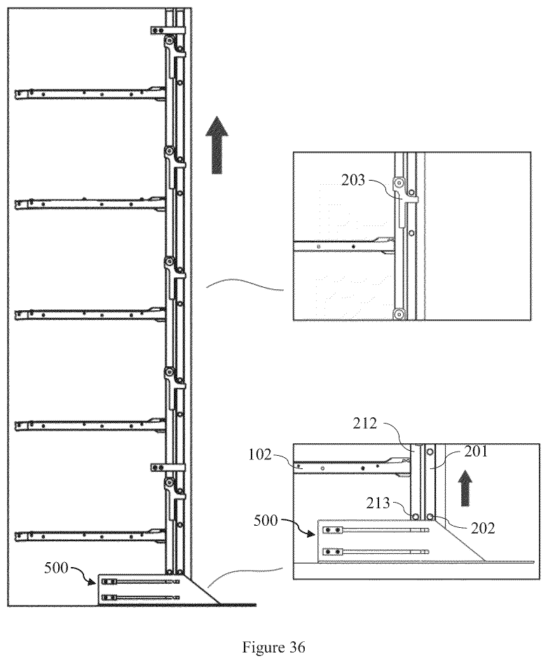

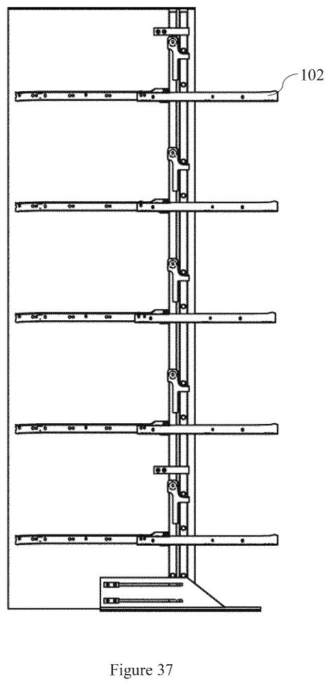

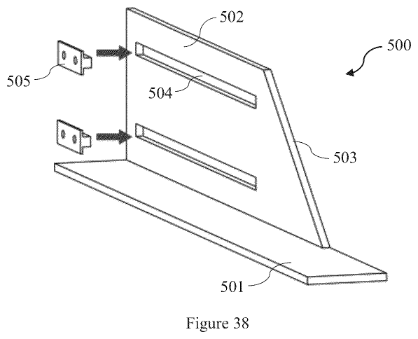

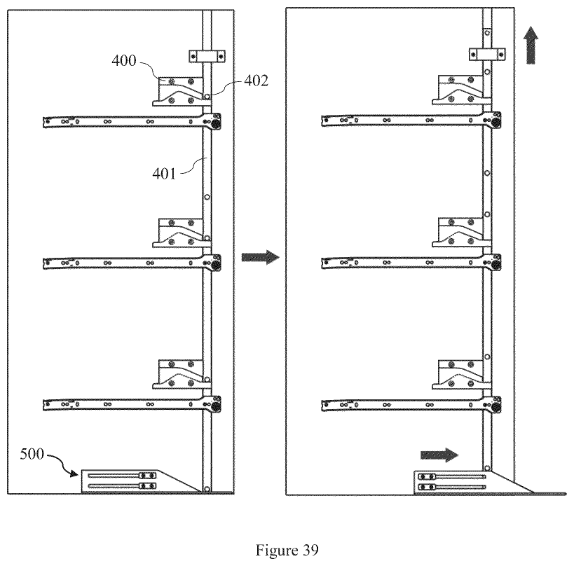

Referring to FIGS. 35-37, a second embodiment of the anti-tipping mechanism (500) is illustrated. In this embodiment, the anti-tipping mechanism (500) also includes the base (501) and the attachment portion (502). Additionally to the first embodiment, the attachment portion (502) further includes one or more grooves (504), one or more fastening members (505) that attached to the cabinet (100) and are slidable along the grooves (504), and a tapered surface (503) for guiding the movable bar (212) and/or the locking bar (201) to the suspended position. This embodiment allows the anti-tipping mechanism (500) to slide between the first position and the second position. The functions of the anti-tipping mechanism (500) can be activated or disabled according to its position between the first and second positions. Similarly, this embodiment of the anti-tipping mechanism (500) can be used to disable the alternative embodiment of the interlocking mechanism as shown in FIG. 39.

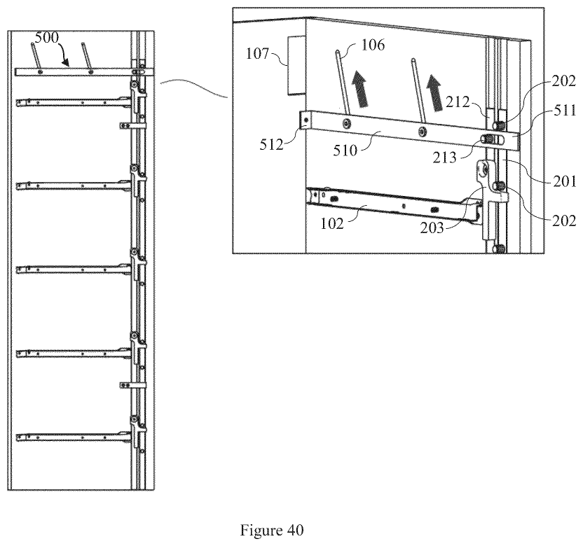

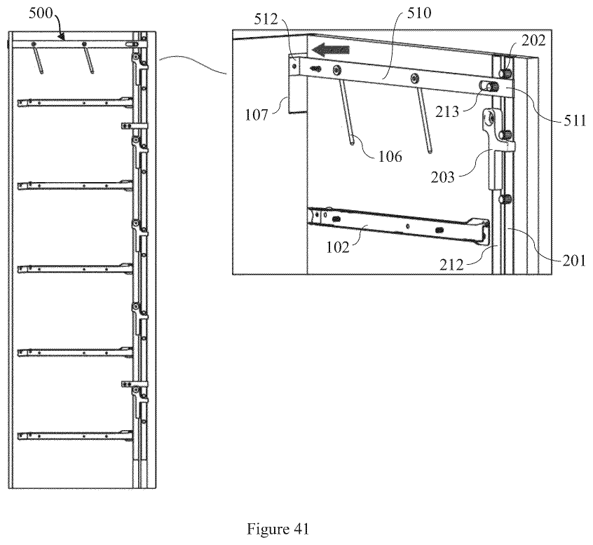

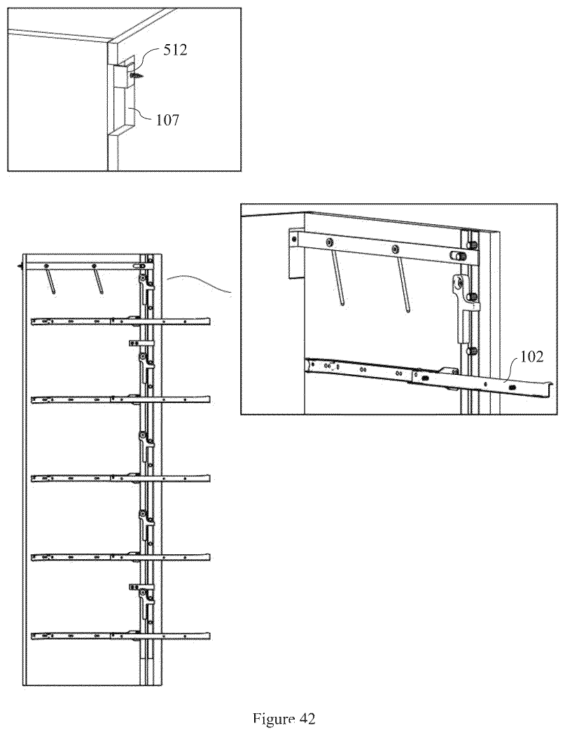

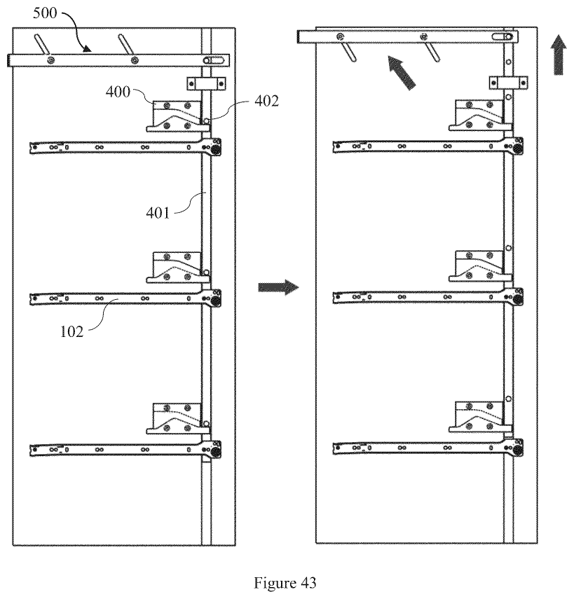

Referring to FIGS. 40-42, a third embodiment of the anti-tipping mechanism (500) is illustrated. In this embodiment, the anti-tipping mechanism (500) comprises an elongate body (510) with a first end (511) and a second end (512). Preferably, the elongate body (510) is slidably attached to one or more slot (106) on the cabinet (100). The elongate body (510) is movable along the slot (106) between the first position and the second position. The first end (511) engages a topmost protrusion (202, 213) of movable bar (212) and/or the locking bar (201) so that the first end (511) can suspend the movable bar (212) and/or the locking bar (201) when the anti-tipping mechanism (500) is moved to the second position. The second end (512) is extended out from the cabinet (100), when the anti-tipping mechanism is in the second position, via an opening (107) of the cabinet (100), for mounting to a wall structure. Similarly, this embodiment of the anti-tipping mechanism (500) can be used to disable the alternative embodiment of the interlocking mechanism as shown in FIG. 43.

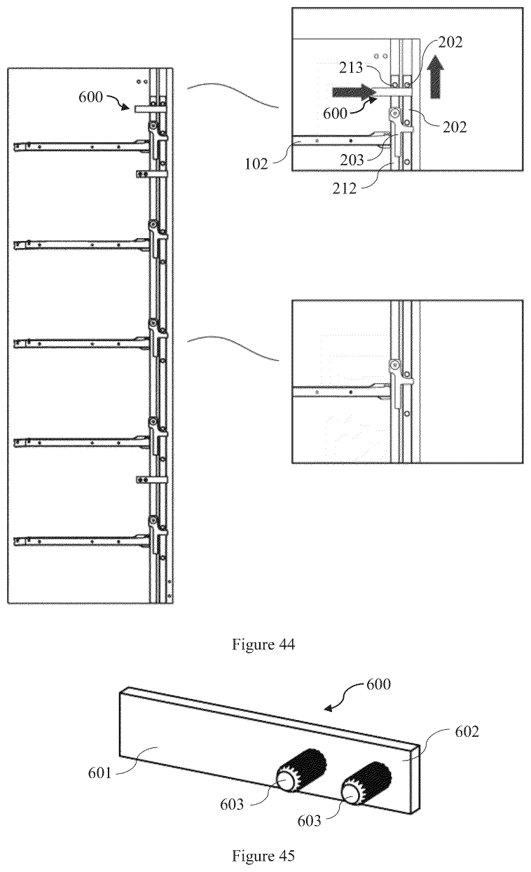

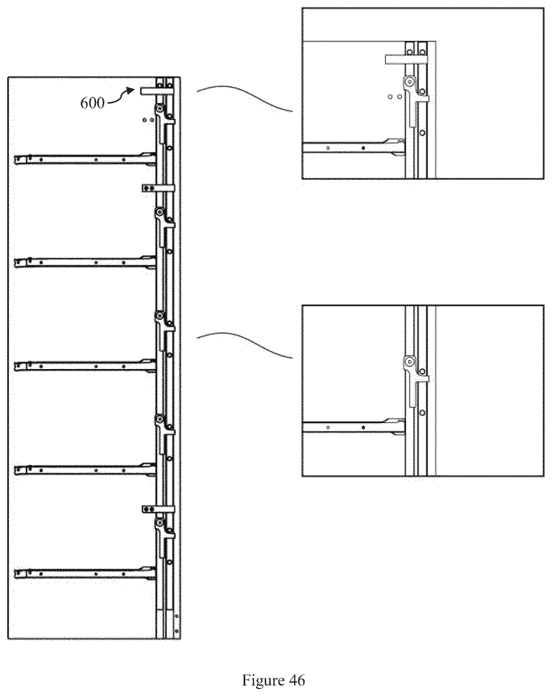

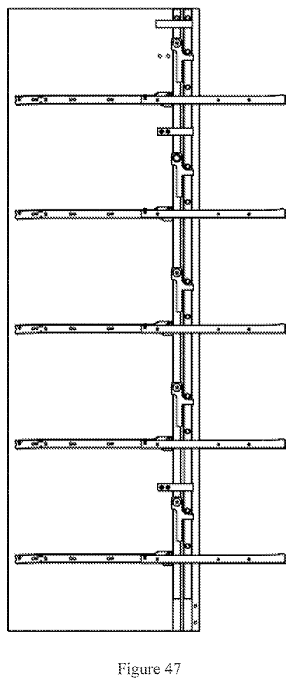

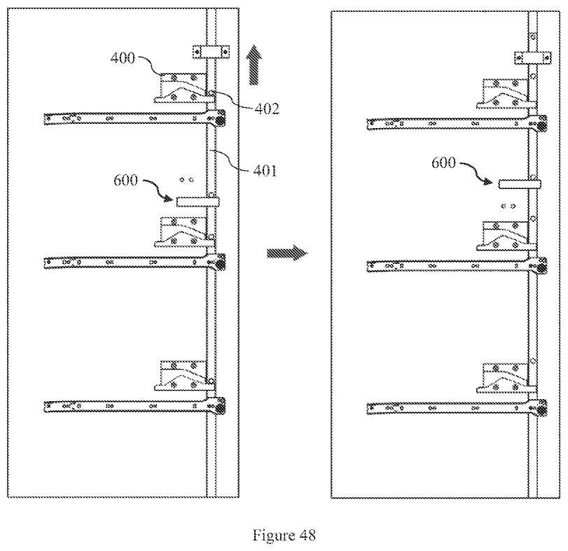

Referring to FIGS. 44-47, a bar holder (600) can be provided to perform only the second function of the anti-tipping mechanism (500) which is suspending the movable bar (212) and/or the locking bar (201) in such a way that the functions of the interlocking mechanism (200) are disabled. The bar holder (600) can be attached to a first position of the cabinet (100) where it is non-operational, as shown in FIG. 44, or a second position of the cabinet (100) where it suspends the movable bar (212) and/or the locking bar (201), as shown in FIGS. 46 and 47. Preferably, the bar holder (600) comprises a body with a first end (601) engages one of the protrusions (202, 213) of movable bar (212) and/or the locking bar (201), and a second end (602) having one or more dowel pins (603) to be inserted into one or more pin holes of the cabinet (100). Similarly, the bar holder (600) can be used to disable the alternative embodiment of the interlocking mechanism as shown in FIG. 48.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. A cabinet, comprising:
a plurality of drawers, each coupled with a sliding mechanism for the respective drawer to be slid between a closed position and an open position; and
an interlocking mechanism which is triggered, by the movement of one of the drawers, to switch between a locked configuration where one of the drawers is in the open position while the remaining drawers are locked in the closed position and an unlocked configuration where any one of the drawers can be moved from the closed position to the open position;
wherein the interlocking mechanism comprises:
a locking bar slidably disposed on an inner side wall of the cabinet, having a plurality of spaced protrusions distributed along a length of the locking bar, wherein the locking bar is movable between a locked position and an unlocked position; and
a plurality of rotatable blocks, each block having a first portion pivotably connected to the inner side wall of the cabinet, a second portion engagable by the sliding mechanism of a respective drawer, and a third portion that is engagable with one of the protrusions;
wherein when one of the drawers is moving towards the open position, the sliding mechanism of that particular drawer engages the second portion of the corresponding rotatable block to cause the third portion of the corresponding rotatable block to engage with the respective protrusions and to move the locking bar to the locked position, the remaining protrusions of the locking bar are also moved to a position that intercept a rotation pathway of the remaining rotatable blocks such that the sliding mechanisms of the remaining drawers are prevented from movement.

2. The cabinet according to claim 1, wherein the sliding mechanism is a roller slide.

3. The cabinet according to claim 1, wherein the rotatable block is a T-shaped block.

4. The cabinet according to claim 1, wherein the rotatable block comprises a through hole for receiving a fastening means.

5. The cabinet according to claim 1, wherein the rotatable block comprises a chamfer for facilitating the movement of the drawer.

6. The cabinet according to claim 1, wherein the rotatable block comprises a receiving portion for receiving a supporting means such that the rotatable block is held at an outward position.

7. The cabinet according to claim 1, further comprising a guiding means for guiding movement of the locking bar.

8. The cabinet according to claim 7, further comprising a limiting member for securing the movement of the locking bar within the guiding means.

9. The cabinet according to claim 1, wherein the cabinet is a multi-column cabinet having a first column storage space and a second column storage space separated by an intermediate panel, at least two of the locking bars are respectively disposed on one side of the intermediate panel, wherein the locking bars are linked to move in a synchronized manner between the locked position and the unlocked position.

10. The cabinet according to claim 9, wherein the intermediate panel includes a slot through which a linkage can move along a length of the slot and pass through the slot to connect the locking bars on the respective sides of the intermediate panel.

11. The cabinet according to claim 1, further comprising a second interlocking mechanism for securing all the drawers in their closed position when the cabinet is tilted.

12. The cabinet according to claim 11, wherein the second interlocking mechanism comprises a further protrusion on the locking bar and a further rotatable block pivotably connected to the inner side wall in such a way that it rotates in relative to the cabinet, while the cabinet is tilted, to a position that engages the further protrusion, thereby preventing the locking bar, the rotatable blocks, and the sliding mechanisms of the drawers from any movement.

13. The cabinet according to claim 1, wherein the rotatable blocks are connected to a movable bar that is slidable on the inner side wall between an operational position where the sliding mechanisms of the drawers are engagable with their respective rotatable blocks and a non-operational position where the sliding mechanisms are not engagable with their respective rotatable blocks.

14. The cabinet according to claim 13, further comprising an anti-tipping mechanism that simultaneously prevents the cabinet from toppling over and disables functions of the interlocking mechanism.

15. The cabinet according to claim 14, wherein the anti-tipping mechanism is slidably attached to the cabinet in such a way that it can move between a first position where the functions of the anti-tipping mechanism are disabled and a second position where the functions of the anti-tipping mechanism are activated.

16. The cabinet according to claim 15, wherein the anti-tipping mechanism comprises a base extended out from the cabinet to increase a footprint of the cabinet, and an attachment portion that facilitates attachment of the anti-tipping mechanism to the cabinet and suspends the movable bar in the non-operational position.

17. The cabinet according to claim 16, wherein the attachment portion further suspends the locking bar in a position where the protrusions on the locking bar do not obstruct the sliding path way of the sliding mechanisms of the drawers.

18. The cabinet according to claim 17, wherein the attachment portion includes at least one groove, at least one fastening member attached to the cabinet and being slidable along the grooves, and a tapered surface for guiding the movable bar or the locking bar to the suspended position.

19. The cabinet according to claim 15, wherein the anti-tipping mechanism comprises an elongate body having a first end for suspending the movable bar or the locking bar in the non-operational position and a second end extended out from the cabinet for mounting to a wall structure.

20. The cabinet according to claim 13, further comprising a bar holder for suspending the movable bar or the locking bar in such a way that the functions of the interlocking mechanism are disabled.
